(19) United States
(12) Patent Application Publication
(10) Pub. No.: US 2013/0175337 A1
(43) Pub. Date: Jul. 11, 2013

(54) CONTEXT AWARE SMART PACKAGING AND REAL-TIME MERCHANDISING

(71) Applicant: Kitchology LLC, Newark, DE (US)

(72) Inventors: Alain C. Briancon, Poolesville, MD (US); Iris S. Sherman, Kennebunk, ME (US); Marvin G. Imus, Mattawan, MI (US); Chris A. Giacoponello, Pottstown, PA (US); Ellen S. Foreman, State College, PA (US); Howard E. Goldberg, Wynnewood, PA (US)

(73) Assignee: KITCHOLOGY LLC, Newark, DE (US)

(21) Appl. No.: 13/734,541

(22) Filed: Jan. 4, 2013

Related U.S. Application Data
(60) Provisional application No. 61/583,432, filed on Jan. 5, 2012.

(51) Int. Cl. G06F 17/30

(52) U.S. Cl. CPC G06F 17/30002
USPC 235/375

(57) ABSTRACT

The subject matter described herein enhances the interaction of consumers with food packaging using cellphones and other portable scanners. Specifically, it enhances consumer's purchase decision and use decisions at key moments at home and store.

### CROSS REFERENCE TO RELATED APPLICATION

This application claims the benefit of U.S. provisional application No. 61/583,432, filed Jan. 5, 2012, which is incorporated herein by reference as if fully set forth.

### FIELD OF INVENTION

The subject matter described herein relates to advanced dynamic interaction between consumer and packaged food.

### BACKGROUND

The profitability of food retailers, such as groceries or supermarkets, and Consumer Packaged Goods (CPG) producers can be adversely affected by high commodity prices, transportation costs, high labor costs, in store waste and the high cost of advertising and product development. Retailers need to optimize use of their layout and display space in ways that integrate consumer understanding of shopping patterns, decision patterns, impact of number of SKUs on the decision to visit a store, and an aisle of location within that store. CPG producers, which control product definition need to optimize brand and marketing experiences that include consumer understanding of the frequency and type of consumer communications. They are doing this within the confines of Government regulations on labeling. Such consumer understanding is costly to obtain and is often incomplete. Typically, the data collection through which consumer habit analysis is extrapolated is done at the point of sale. Influencing consumers though couponing is typically done on a post-purchase basis, either at the point of sale and/or at home before new purchasing activities are started. Neither of these are highly targeted and aligned to individual consumer preferences, and thereby suffer from low redemption rates and low impact, while at the same time increasing costs due to over-distribution. Coupons are typically distributed to a broad audience to find a limited interest audience.

Such data collection is widespread and fails to provide specific insights as to a consumer's behavior, namely the reasons a consumer chooses a particular product for purchase. Today, retailers do not have a system with the ability to gain consumer insights nor influence purchase at either the point of purchase decision or the point of use decision. The only known method of gaining a consumer's insight at the point of purchase decision is by hiring one or more persons skilled and trained at conducting focus group testing to follow the consumer in their retail store. This is costly in both time and personnel resources, and may be uncomfortable to individual consumers.

As one of their principal expenditures consumers are increasingly sensitive and conscious of cost inflation in their monthly food bills. Yet, time pressures in modern lifestyles limit the time consumers can allocate to searching and cutting out coupons or other saving mechanisms typically offered by retailers and CPGs. Therefore, consumers need a means to optimize their shopping time and food costs, while increasing the relevance of their purchases to minimize redundant purchases while insuring that all ingredients necessary for menu planning are in the household pantry.

Retailers currently use elaborate in-store presentations on aisles, end caps, shopping carts and shelves to seize the consumer's attention and influence product selections before, during, and after a consumer's product consideration. These non-targeted, non-customizable attempts to influence consumers are often disregarded by the consumer, whose objective is to get out of the store as fast as possible, completing the task of shopping while talking on their cell phone or interacting with media on other personal handheld devices, such as smartphones. Prior attempts to deal with consumer disregard of retailer presentations have involved methods that proved to be expensive, inefficient, ineffective and annoying.

Food industry suppliers need low-cost, highly effective methods for responding to and influencing a consumer's product selection and decision-making at home and in stores. Such methods should aim to enhance, simplify and expedite a consumer's experience on a cost-neutral (and time-neutral) basis to consumers and a cost-neutral to positive impact to retailer profit margins. Retailers are interested in maximizing profitability by moving consumers to higher margin products or in-store brands. Implementations vary whether the retailer uses an Every Day Low Pricing (EDLP) strategy or a Promotional (HiLo) strategy. This has typically been done through broad store brand promotions. Due to their lack of specific consumer targeting, these may achieve market share objectives at the expense of profitability. Moreover, such broad promotions may also adversely impact relationships with certain CPG manufacturers (whether they are supplying the store brand or not). Another method is changing store configuration between center of store and side of the store, which is costly due to its labor intensity, and disruptive to the store, and the shopper.

To address these issues, attempts have been made to tie marketing messages to the item being purchased by the consumer, while that item is in the hand of the consumer or the shopping cart. These initial attempts, because they were developed before smart phones supporting GPS, high-speed communication and fast processing chip were readily available, have suffered from major limitations.

In U.S. Pat. No. 7,225,979, Silverbrook et al. teaches interaction between objects and consumers based on coded data printed on the document being examined. The inventors teach limited interactivity where the co-location of a sensing device (an electronic pen) against the package triggers the extraction of non-interactive information from the web. The invention does not consider or anticipate the case where the sensing device has memory allocated to store and dynamically process interactions that can vary based on considerations such as historical purchase information, stored or retrieved preferences, alternative purchase possibilities and other relationships between the product being considered for purchase and the consumer owner or user of the device.

Knowles in U.S. Pat. No. 5,905,251, and Wilz and Knowles in U.S. Pat. No. 6,464,139 teach another limited example of an interactive packaging application. There, a hand held scanner is used to extract an encoded applet visually encoded in the form of a bar code. QR codes were not yet popularized when the invention was developed in the former and a URL in the later. These narrow inventions do not consider the utilization of information, if any, that may be stored in the scanner, other than a transient basis to alter the consumer experience, nor do they allow or direct themselves in any way to customization of the consumer shopping experience.

### SUMMARY

In an aspect, the invention relates to a computer-implemented method. The method includes providing a first set of instructions configured to cause a portable device to: i) scan all or a portion of packaging, ii) locate a visual indicator in the visible portion of packaging, iii) map said visual indicator into at least one index, iv) access one or more extraction attributes; identifying one or more digital objects based on the at least one index and the one or more extraction attributes; and presenting an interactive interface comprising information about the one or more digital objects and a control for selecting a particular digital object of the one or more digital objects.

In an aspect, the invention relates to a computer-implemented method. The method includes providing a first set of instructions configured to cause a portable device to: i) scan all or a portion of packaging, ii) locate a visual indicator in the visible portion of packaging, iii) map said visual indicator into at least one index, iv) access one or more extraction attributes, and v) send the at least one index and the one or more extraction attributes to a server; receiving, at the server, from the portable device, a first request comprising the at least one index and the one or more extraction attributes; identifying one or more digital objects by the server, based on the at least one index and the one or more extraction attributes; sending to the portable device a second set of instructions by the server in response to the first request, configured to cause the portable device to: i) present an interactive interface comprising information about the one or more digital objects and a control for selecting a particular digital object of the one or more digital objects; ii) send information identifying the particular digital object to a server upon a consumer selecting the control; and iii) send to the server, from the portable device, a second request identifying the particular digital object.

In an aspect, the invention relates to a computer-implemented method. The method includes providing a first set of instructions configured to cause a first portable device to: i) scan a portion of packaging, ii) locate a visual indicator in the visible portion of packaging, iii) map said visual indicator into an index, and iv) access one or more of a first set of extraction attributes; transmitting the index and the first set of extraction attributes to a second portable device; accessing one or more of a second set of extraction attributes; sending the index and the first or second set of extraction attributes to a server by the second portable device; receiving, at the server, from the second portable device, a first request comprising the index and said attributes; identifying one or more digital objects by the server based on the index and said attributes; sending a second set of instructions to the second portable device by the server, in response to the first request, configured to cause the second portable device to: i) present an interactive interface comprising information about the one or more digital objects and a control for selecting a particular digital object of the one or more digital objects, ii) send information identifying the particular digital object to a server upon a consumer selecting the control, and iii) send to the server, from the second portable device, a second request identifying the particular digital object.

In an aspect, the invention relates to a non-transitory machine-readable storage medium having recorded and stored thereon instructions that, when executed, perform actions including: scanning a portion of packaging; locating a visual indicator in the visible portion of packaging; mapping said visual indicator into at least one index; accessing one or more context attributes; presenting an interactive interface comprising information about one or more digital objects; presenting to a consumer a control for selecting a particular digital object of the one or more digital objects; and sending information identifying the particular digital object to a server upon a consumer selecting the control.

In an aspect, the invention relates to a non-transitory machine-readable storage medium having recorded and stored thereon instructions that, when executed, performs actions including: providing a first set of instructions configured to cause a portable device to: i) scan all or a portion of packaging, ii) locate a visual indicator in the visible portion of packaging, iii) map said visual indicator into at least one index, iv) access one or more extraction attributes; identifying one or more digital attributes based on the at least one index and the one or more extraction attributes; presenting an interactive interface comprising information about the one or more digital objects and a control for selecting a particular digital object of the one or more digital objects; and storing use of the particular digital object into non-volatile memory upon a consumer selecting the control.

In an aspect, the invention relates to a non-transitory machine-readable storage medium having recorded and stored thereon instructions that, when executed, performs actions including: providing a first set of instructions configured to cause a portable device to: i) scan all or a portion of packaging, ii) locate a visual indicator in the visible portion of packaging, iii) map said visual indicator into at least one index, iv) access one or more extraction attributes; identifying one or more digital objects based on the at least one index and the one or more extraction attributes; presenting an interactive interface comprising information about the one or more digital objects and a control for selecting a particular digital object of the one or more digital objects; and sending information identifying the particular digital object to a server upon a consumer selecting the control.

In an aspect, the invention relates to an interactive packaging processing system comprising: one or more portable devices capable of scanning packages, said portable devices comprising a processing unit, memory, and a user interface; the one or more portable devices capable of extracting one or more extraction attributes; at least one of the one or more portable devices capable of selecting one or more digital objects based on information from scanning the packages and the one or more attributes and presenting the one or more digital objects to the portable device user interface.

In an aspect, the invention relates to an interactive packaging processing system comprising: one or more portable devices capable of scanning packages, said portable devices comprising a processing unit, memory and user interface and said portable devices capable of extracting one or more extraction attributes; one or more servers comprising one or more digital objects stores, a central processing unit and memory, said one or more digital objects stores storing one or more digital objects; at least one portable device capable of scanning a package, extracting a first of set of one or more of said attributes and transmitting information about scanned package; at least a second portable device capable of extracting a second set of one or more of said attributes; said at least one portable device capable of exchanging said first set of attributes to a second device; said portable devices capable of transmitting first set of attributes, second set of attributes and information about scanned package to one or more servers, said one or more servers capable of selecting one or more digital objects based on scanned package information and attributes, and said servers capable of transmitting one or more digital objects to one or more portable devices.

### BRIEF DESCRIPTION OF THE DRAWINGS

The following detailed description of the preferred embodiments of the present invention will be better understood when read in conjunction with the appended drawings. For the purpose of illustrating the invention, there are shown in the drawings particular embodiments. It is understood, however, that the invention is not limited to the precise arrangements and instrumentalities shown. In the drawings:

FIG. 1 illustrates components of a basic system which includes scanning of a food item(s) performed by a consumer holding an extracting device or using a device holding said device.

FIG. 2 illustrates how an extracting device (201) may be architected to enable context aware interaction with packaging.

FIG. 3 illustrates a system that supports context aware interaction with packaging.

FIG. 4 illustrates the structure of some of the key databases used in the supplier servers described in FIG. 3 above.

FIG. 5 illustrates the logic and flow of digital objects used to provide context aware interaction to consumers.

FIG. 6 illustrates how the context of a consumer interaction can be computed.

FIG. 7 illustrates nominal examples of the evolution of contexts for both store (701) and home (702) scanning scenarios.

FIG. 8 illustrates the scanning of a specific food item used to display multiple media objects on multiple phones, and methods of facilitating a group purchase of said items.

FIG. 9 illustrates another embodiment including enabling customized and dynamic pricing as well as real-time price bidding.

FIG. 10 illustrates another embodiment.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. The terms “memory” and “memory device” are used interchangeably. The terms “Stock Keeping Unit”, “SKU” and “item” are used interchangeably. The terms “state” and “context” are used interchangeably. The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

Described herein are methods and apparatus for the creation and use of dynamic individualized interactions between consumers and packaging while at home or shopping, enabling among others dynamic and/or context sensitive pricing, real time bidding for the consumer business, and consumer/context tailored information, or referrals.

Embodiments include computer implemented methods. In an embodiment, the method includes providing a first set of instructions configured to cause a portable device to scan all or a portion of packaging, locate a visual indicator in the visible portion of packaging, map said visual indicator into at least one index, and access one or more extraction attributes. The one or more attraction attributes may include location, speed, time, velocity, orientation, sound, lighting, vibration, repeated motion, distance to packaging, distance between packaging and nearby related objects, portable device parameters, application parameters, and identification parameters. The method may also include identifying one or more digital objects based on the at least one index and the one or more extraction attributes and presenting an interactive interface comprising information about the one or more digital objects and a control for selecting a particular digital object of the one or more digital objects. The step of identifying may also include transmitting the at least one index and the one or more attraction attributes to a second portable device. The second portable device may access the at least one index and the one or more extraction attributes and the second portable device may identify one or more digital objects based on the at least one index and the one or more extraction attributes. Alternatively, the step of identifying may include transmitting the at least one index and the one or more extraction attributes to a second portable device, accessing a second set of one or more extraction attributes by the second portable device, and identifying one or more digital objects based on the at least one index, the one or more extraction attributes, and the second set of one or more extraction attributes by the second portable device. The extraction attributes may include location, speed, time, velocity, orientation, sound, lighting, vibration, repeated motion, distance to packaging, distance between packaging and nearby related objects, portable device parameters, application parameters, and identification parameters. The method may include sending at least one of the one or more digital objects to a third portable device.

The method may include storing use of the particular digital object into non-volatile memory upon a user selecting the control. The method may include sending information identifying the particular digital object to a server upon a consumer selecting the control.

The one or more digital objects may include but are not limited to a game, a virtual machine, a form-based questionnaire, a coupon, a discount, an advertisement, a financial instrument, pricing information, nutritional information, allergy information, a recipe, inventory information, geographical information, environmental information or social networking information. The financial instrument may include a currency, a contract, a bid, an equity, a security, a tax, a fixed security, or indexes thereof.

Selecting the particular digital object may be based on one or more of extraction attributes, purchase history, credit history, membership in group, time of day, day of week, environmental conditions, preferences or restrictions.

The method may further include creating a second index to the particular digital object, generating one or more unique transaction identifiers based on that second index, and transmitting one or more transaction data each associated with said identifier to one or more remote servers.

In an embodiment, a computer-implemented method includes providing a first set of instructions configured to cause a portable device to scan all or a portion of packaging, locate a visual indicator in the visible portion of packaging, map said visual indicator into at least one index, access one or more extraction attributes, and send the at least one index and the one or more extraction attributes to a server. The extraction attributes may include location, speed, time, velocity, orientation, sound, lighting, vibration, repeated motion, distance to packaging, distance between packaging and nearby related objects, portable device parameters, application parameters, and identification parameters.

The method may also include receiving, at the server, from the portable device, a first request comprising the at least one index and the one or more extraction attributes, identifying one or more digital objects by the server, based on the at least one index and the one or more extraction attributes, and sending to the portable device a second set of instructions by the server in response to the first request, configured to cause the portable device to present an interactive interface comprising information about the one or more digital objects and a control for selecting a particular digital object of the one or more digital objects, send information identifying the particular digital object to a server upon a consumer selecting the control, and receive at the server, from the portable device, a second request identifying the particular digital object.

The step of identifying may include querying a second server based on at least one of a context attribute, and identifying the one or more digital objects based on the context attribute from the second server, the at least one index and the one or more extraction attributes.

The method may include sending at least one of the one or more digital objects to a second portable device. The one or more digital objects may include at least one of a game, a virtual machine, a form-based questionnaire, a coupon, a discount, an advertisement, a financial instrument, pricing information, nutritional information, allergy information, a recipe, inventory information, geographical information, environmental information or social networking information. The financial instrument may include a currency, a contract, a bid, an equity, a security, a tax, a fixed security, or indexes thereof.

Selecting the particular digital objects may be based on one or more of extraction attributes, purchase history, credit history, membership in group, time of day, day of week, environmental conditions, preferences or restrictions.

The method may include creating a second index to the particular digital object, generating one or more unique transaction identifiers based on that second index, and transmitting one or more transaction data each associated with said identifier to one or more remote servers.

In an embodiment, the computer-implemented method may include providing a first set of instructions configured to cause a first portable device to scan a portion of packaging, map said visual indicator into an index, and access one or more of a first set of extraction attributes. The extraction attributes may include location, speed, time, velocity, orientation, sound, lighting, distance to packaging, portable device parameters, application parameters, and identification parameters.

The method may also include transmitting the index and the first set of extraction attributes to a second portable device, accessing one or more of a second set of extraction attributes by the second portable device, sending the index and the first or second set of extraction attributes to a server by the second portable device, receiving, at the server, from the second portable device, a first request comprising the index and said attributes, identifying one or more digital objects by the server based on the index and said attributes, sending a second set of instructions to the second portable device by the server, in response to the first request, configured to cause the second portable device to present an interactive interface comprising information about the one or more digital objects and a control for selecting a particular digital object of the one or more digital objects, send information identifying the particular digital object to a server upon a consumer selecting the control, and receive at the server, from the second portable device, a second request identifying the particular digital object.

The second set of extraction attributes may include location, speed, time, velocity, orientation, sound, lighting, vibration, repeated motion, distance to packaging, distance between packaging and nearby related objects, portable device parameters, application parameters, and identification parameters.

The method may include sending at least one of the one or more digital objects to a second portable device. The one or more digital objects may include a game, a virtual machine, a form-based questionnaire, a coupon, a discount, an advertisement, a financial instrument, pricing information, nutritional information, allergy information, a recipe, inventory information, geographical information, environmental information or social networking information. The financial instrument may include a currency, a contract, a bid, an equity, a security, a tax, a fixed security, or indexes thereof.

Selecting the particular digital objects may be based on one or more of extraction attributes, purchase history, credit history, membership in group, time of day, day of week, environmental conditions, preferences or restrictions.

The method may also include creating a second index to the particular digital object, generating one or more unique transaction identifiers based on that second index, and transmitting one or more transaction data each associated with said identifier to one or more remote servers.

Embodiments include a non-transitory machine-readable storage medium. The non-transitory machine-readable storage medium may include recorded and stored instructions thereon that, when executed, perform actions including scanning a portion of packaging, locating a visual indicator in the visible portion of packaging. mapping said visual indicator into at least one index, accessing one or more context attributes, presenting an interactive interface comprising information about one or more digital objects, presenting to a consumer a control for selecting a particular digital object of the one or more digital objects, and sending information identifying the particular digital object to a server upon a consumer selecting the control.

The one or more context attributes may include location, speed, time, velocity, orientation, sound, lighting, vibration, repeated motion, distance to packaging, distance between packaging and nearby related objects, portable device parameters, application parameters, and identification parameters.

The non-transitory machine-readable storage medium may also include sending the index and one or more extraction attributes to a server, and receiving a set of instructions, prior to presenting an interactive interface comprising information about one or more digital objects.

Embodiments include a non-transitory machine-readable storage medium having recorded and stored thereon instructions that, when executed, performs actions including providing a first set of instructions configured to cause a portable device to scan all or a portion of packaging, locate a visual indicator in the visible portion of packaging, map said visual indicator into at least one index, access one or more extraction attributes, identifying one or more digital attributes based on the at least one index and the one or more extraction attributes, presenting an interactive interface comprising information about the one or more digital objects and a control for selecting a particular digital object of the one or more digital objects, and storing use of the particular digital object into non-volatile memory upon a consumer selecting the control.

The extraction attributes may include location, speed, time, velocity, orientation, sound, lighting, vibration, repeated motion, distance to packaging, distance between packaging and nearby related objects, portable device parameters, application parameters, and identification parameters.

Embodiments include a non-transitory machine-readable storage medium having recorded and stored thereon instructions that, when executed, performs actions including providing a first set of instructions configured to cause a portable device to scan all or a portion of packaging, locate a visual indicator in the visible portion of packaging, map said visual indicator into at least one index, access one or more extraction attributes, identifying one or more digital objects based on the at least one index and the one or more extraction attributes, presenting an interactive interface comprising information about the one or more digital objects and a control for selecting a particular digital object of the one or more digital objects, and sending information identifying the particular digital object to a server upon a consumer selecting the control.

Embodiments include an interactive packaging processing system. The interactive packaging processing system may include one or more portable devices capable of scanning packages, said portable devices comprising a processing unit, memory, and a user interface, the one or more portable devices capable of extracting one or more attributes at least one of the one or more portable devices capable of selecting one or more digital objects based on information from scanning the packages and the one or more attributes and presenting the one or more digital objects to the portable device user interface.

The one or more attributes may include location, speed, time, velocity, orientation, sound, lighting, vibration, repeated motion, distance to packaging, distance between packaging and nearby related objects, portable device parameters, application parameters, and identification parameters.

Embodiments include an interactive packaging processing system. The interactive packaging processing system may include one or more portable devices capable of scanning packages, said portable devices comprising a processing unit, memory and user interface and said portable devices capable of extracting one or more attributes, one or more servers comprising one or more digital objects stores, a central processing unit and memory, said one or more digital objects stores storing one or more digital objects, at least one portable device capable of scanning a package, extracting a first of set of one or more of said attributes and transmitting information about scanned package, at least a second portable device capable of extracting a second set of one or more of said attributes, said at least one portable device capable of exchanging said first set of attributes to a second device, said portable devices capable of transmitting first set of attributes, second set of attributes and information about scanned package to one or more servers, said one or more servers capable of selecting one or more digital objects based on scanned package information and attributes, and said servers capable of transmitting one or more digital objects to one or more portable devices.

The attributes may include location, speed, time, velocity, orientation, sound, lighting, vibration, repeated motion, distance to packaging, distance between packaging and nearby related objects, portable device parameters, application parameters, and identification parameters;

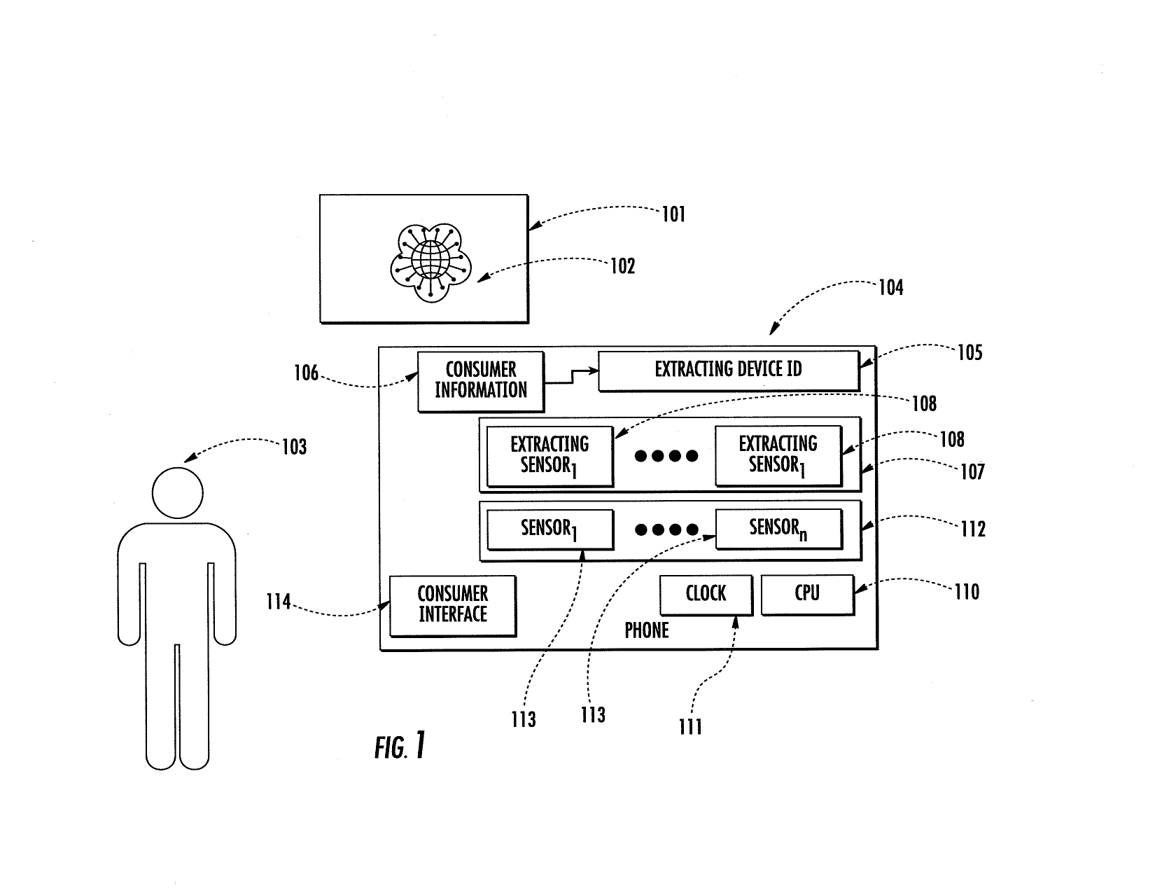

Referring to FIG. 1, components of a basic system which includes scanning of a food item(s) performed by a consumer holding an extracting device or using a device holding said device is illustrated. The extracting device may include but is not limited to a cell phone, an infrared scanner, a tablet, RFID reader, a RFID enabled or Near-Field Communication (NFC) enabled device or a similar portable device with access to internet sourced information. The extracting device can of course be multi-functional. The device holding device can be, but not limited to, a cart or a basket.

Referring to FIG. 1, a food item (101) contains an identifiable mark (102), which can be a logo, UPC code, or another similar type of mark. The consumer (103) holds an extracting device (104) and uses it to interact with food item(s). This extracting device has at least one device ID (105) that is unique to him. This device ID can be derived from a hardware component inside the extracting device such as IMEI (International Mobile Equipment Identity), Media Access Control (MAC) Address, Integrated Circuit Card Identifier (ICCID) of a Subscriber Identification Module (SIM). The device ID can also be derived from consumer information (106) such as email address, account login information, name. An extraction sensor bank (107) holds one or more extracting sensors (108), (109) each adapted to a specific type of meta-element (102). The extracting device is controlled by a CPU (110), typically a micro controller such Texas Instrument MSP430 or Apple A5 with volatile and nonvolatile memory. A clock or clock subsystem (111) maintains time and date. A bank (112) of sensors/sensor subsystems (113) is used to capture different attributes. In an embodiment, one of the sensors is an assisted-GPS to capture location information. In another embodiment, one of the sensors extracts the SSID or the certification information associated with a Wi-Fi Wireless LAN system. In another embodiment, temperature is being measured. In yet another embodiment, a single pixel sensor, such as by not limited to Charge-Coupled Device (CCD) or Complementary Metal-Oxide-Semiconductor (CMOS) sensor is used to measure light. A consumer interface (114) is used to interface with the consumer. In an embodiment, the consumer interface may include but is not limited to at least one of a visual, audio or textual interface.

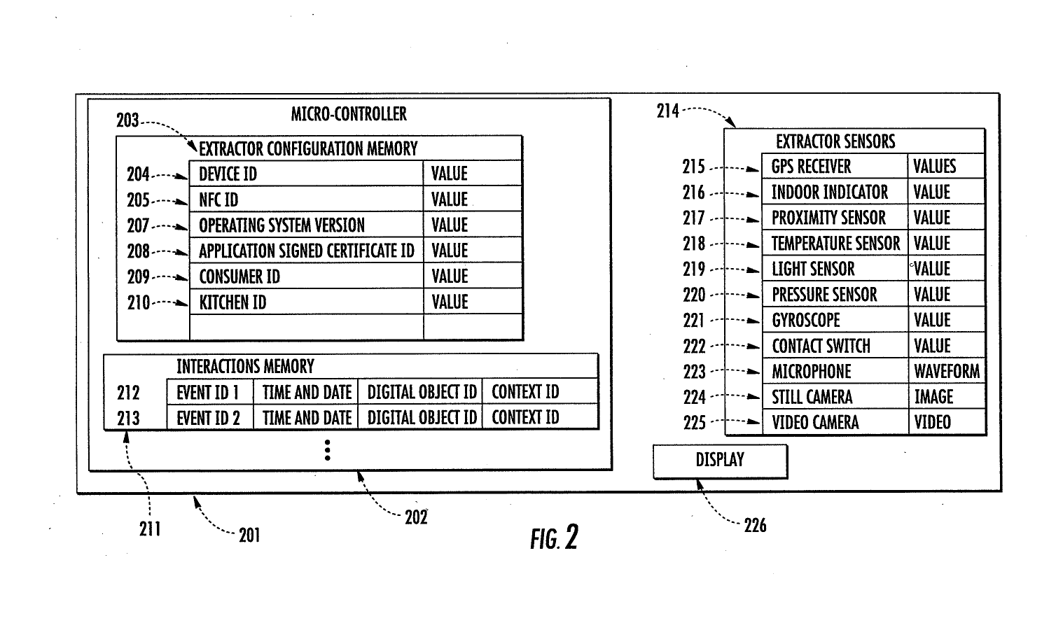

Referring to FIG. 2, methods in which an extracting device (201) may be architected to enable context aware interaction with packaging are illustrated. This device is controlled by a micro-controller (202). This microcontroller includes a memory device, herein referred to as Extractor Configuration Memory or ECM (203), typically non-volatile (EEPROM or FLASH memory) to store configuration operation about the extractor hardware and software it hosts. This ECM may include but is not limited to: Device ID (204), typically set at manufacturing and unique to each extractor, NFC ID (205) if used also as an electronic wallet, Operating system Version Number (207), Application Signed Certification ID (208) used to register application with the operating system provider, Consumer ID (209) used to identify primary consumer of extracting device, Kitchen ID (210) an identifier of the primary kitchen group the consumer uses. The microcontroller can also include (or have access to) a memory bank that stores recent transactions dubbed the Extractor Actions Memory or EAM (215). This may be a dedicated memory area or may be shared with other applications. An event with EventID1 (212) and another one with EventID2 (213) are stored. Each event has among other attributes the time and date recorded, event type (capturing information such as whether the information/exchange associated with the event was pulled, pushed, one-on-one, broadcast, private, public consumer-initiated, etc.) and relevance code used to categorize and organize which past actions are relevant to consider as part of a specific transaction or set of transactions. The extractor has also a bank (214) of sensors used to capture different attributes. A GPS Receiver (215) is used to capture location and speed. An indoor locator (216) is used to detect whether the extractor is indoor or outdoor. This can be accomplished by looking at RF channel response or light spectrum. A proximity sensor (217) (capacitive, inductive or otherwise) is used to check whether the consumer or an object is near the extractor. A temperature sensor (218) measures temperature (many micro-controllers have a built in temperature sensor. A light sensor (219) measures lighting intensity. A pressure sensor (220) measures pressure. A gyroscope (221) measures the three-dimensional position of the extractor. A contact switch (222) measures whether the extractor is in contact with a solid or liquid surface. A microphone (223) captures sounds. A still camera (224) captures images. A video camera (225) captures videos. The sensors (215) to (224) can store information collected.

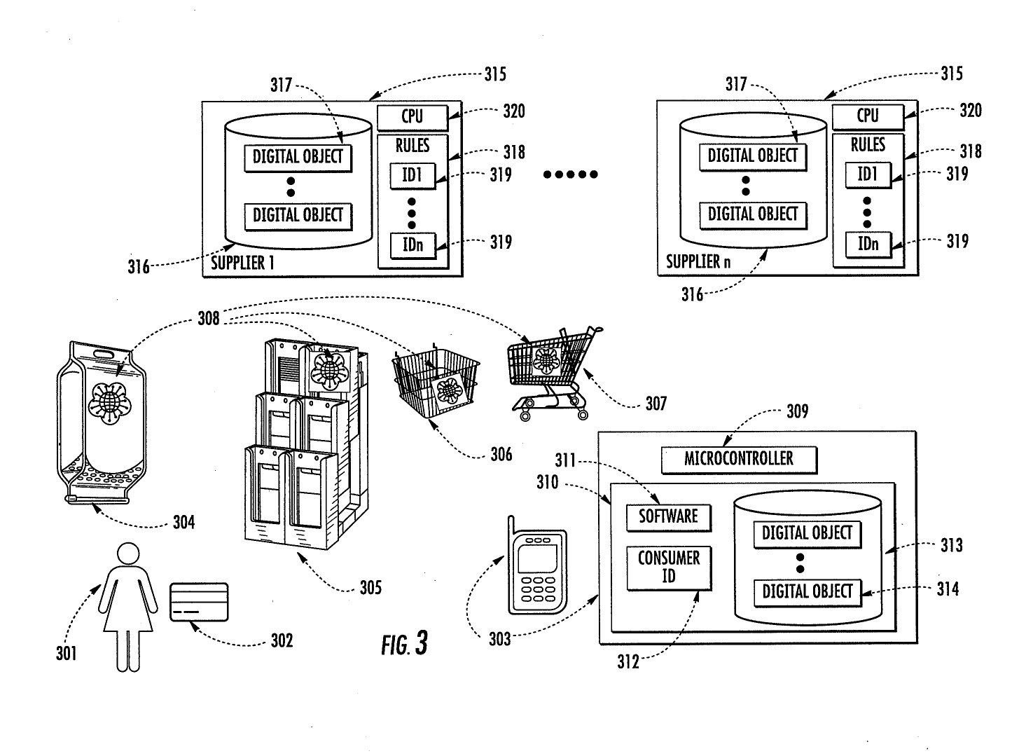

Referring to FIG. 3, a system that supports context aware interaction with packaging is illustrated. A consumer (301) who may have a loyalty card (302) uses his or her extracting device (303) while shopping. The cell phone (303) is brought up close to a food package (304), a merchandising display (305), a shopping basket (306), or a shopping cart (307). The merchandising display may be located by the cashier or point of sales (POS) terminal. It should be noted nothing precludes the interaction between consumer and packaging might take place at the consumer home and is not restricted to be solely at a grocery store, supermarket, or other food retailer. Each of the (304-307) possible items holds one or more uniquely identifiable logo or code (308). In order for the cell phone (303) to add context awareness to the interaction with the food package, merchandising display, basket, or cart, certain items must be present in cell phone, namely a microcontroller (309), memory (310) and software (311). The memory also holds information about the consumer such as consumer ID (312). The memory also holds an object store (313) with one or more digital objects (314). Food suppliers maintained a series of servers (315) used in conjunction with the consumer cell phone to provide a context aware interaction. In this embodiment, suppliers maintain their own servers (315). Each server includes a digital object Store (316) that includes one or more digital objects (317). Program memory (318) maintains the computing; customization, processing or presentation (e.g. display of images or text, play of video or audio, control of vibration), rules of the digital objects organized by ID (319). These IDs can be the same as, or related to one another, through database manipulation, taxonomy, or algorithmically to the consumer ID (312), or unique ID of specific packages, store, or location. These rules are executed by a central processing unit (320). While this figure shows multiple servers distinct from one another holding digital objects, it should be noted that these servers can be located, or can be deployed, using so-called cloud based systems, merged across multiple suppliers, or a combination of the above. Suppliers can be, but not limited to, consumer packaged group manufacturers, restaurants, supermarkets, grocery stores, etc.

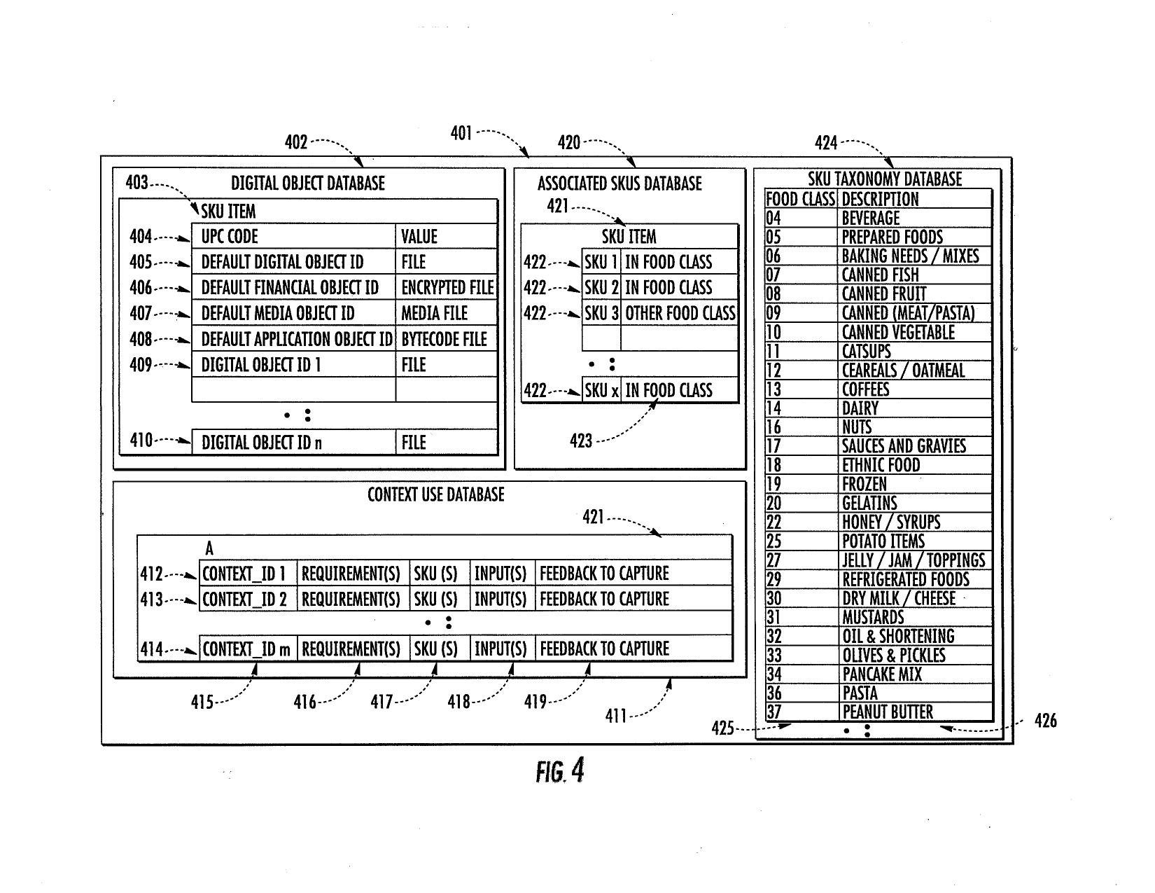

Referring to FIG. 4, the structure of some of the key databases used in the supplier servers described in FIG. 3 above are illustrated. An integrated database structure is shown as (401). The digital object database (402) is organized by SKU (stock keeping unit) (403). For each SKU, a UPC, GS1, serial number, version number or similar code (404) is stored. A default digital object (405) is associated with these SKU item(s). These default digital object IDs may be a brand label or store level advertising message. This default object can be unique to each SKU, or generic to a brand (that is a collection of SKUs), or generic to a store. If appropriate, a default financial object (406), a default media (407), or default application object (408) can also provided. Optionally, in addition to the above, a collection of digital objects (409-410) is provided. These objects can be organized using a multitude of potential architectures ranging, among others, from a flat file format, to a SQL based structure, and/or non-SQL based relational structures. The context use database (411) is another key element used to provide a context aware interaction. This database contains a series of contexts (412, 413, and 414). In this specific embodiment, context information is organized on a per context basis (415). This context information can be organized in other manner, most notably on a per SKU basis. For each context considered, requirements (416) associated with the proper presentation, customization, execution or display of one or more digital objects are encoded. These requirements can be (among others):
a. Restriction on the location such as, but not limited to, home vs. store, store 1 rather than store 2, store location 1 vs. store location 2, location within the store itself
b. Quality of the communication bandwidth available: this can be a quantitative measure, say bit/sec, ICMP performance—or a qualitative measure imparted by the air interface support—say WiFi vs. 3G vs. LTE)
c. Time of day, day of week (certain dry counties in the United States do not allow the purchase of alcohol on Sunday before noon, so marketing wine at that time does not make sense)
d. Age of consumer (the information presented to a three year old should be different from that presented to a 25 year old even if they are both using the same extracting device)
e. Compliance with HIPAA (The Health Insurance Portability and Accountability Act of 1996, Pub. L. 104-191, 110 Stat. 1936, enacted Aug. 21, 1996)
f. Compliance with Children's Online Privacy Protection Act of 1998 (COPPA, 15 U.S.C. §§6501-6506 (Pub. L. 105-277, 112 Stat. 2581-728, enacted Oct. 21, 1998)
g. Other specific interaction between consumer held device and packaging (such as distance between device and packaging or angle of device)
h. The presence of specific tokens or information inside the scanning device or devices associated or paired with said device.

In this embodiment, these contexts are applicable to one or more SKUs (417). These SKUs can be organized in the form of a list of individual SKUs or a range of applicable of SKUs. They can be provided explicitly in a declarative or formulaic manner, organized by class of products (see 424). Consumer input (418), whether directly from the consumer interface (press here button appearing on screen of device, associated device, or paired device), or already stored into memory (possibly based on previous interaction history, group membership, social group membership) are used to shape or alter the consumer interactions, and provide context-awareness to them. In order to provide appropriate business intelligence feedback, and an improved performance of the overall system, feedback from the consumer all can be captured, and stored in memory (419). Examples of such captured data includes the amount of time a device is scanning a specific piece of package, or whether additional information was requested by the consumer. Another optional element of the database is the so-called associated SKU database (420). This associated SKU database is used to provide alternate SKU items to the consumer when scanning an original SKU. For each original SKU item for which a substitute or compliment is to be provided (421), one or more SKUs (422) are listed. Some of these SKUs belong to the same class of food as the original SKU, others don't. An example of class is for instance canned fruits, or nuts. The “in class” and “other food class” (423) are shown in the SKU taxonomy database (424). Here, a series of classes (425) is used to categorize different food items (426) in a manner logical and familiar to consumers. This taxonomy database is optional. Different suppliers will have different taxonomy databases for the SKUs they sell to the marketplace. It should be noted that different digital objects will be stored using different formats, an example, by no means restricting, is provided in (402). Financial objects can be stored as encrypted files. Media objects can be stored using media file formats such as JPEG, HTML5, and mp3 among others. Application objects can be stored using byte code, applet structures, or JavaScript among others.

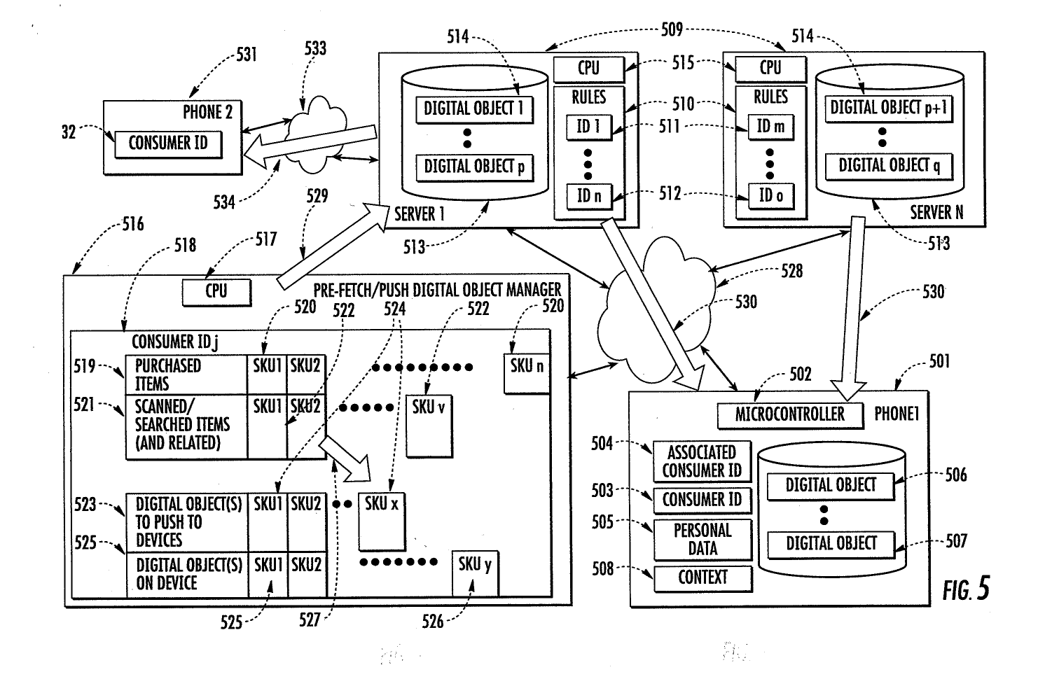

Referring to FIG. 5, the logic and flow of digital objects used to provide context aware interaction to consumers is illustrated. The extracting device (501) includes a microcontroller (502) and the consumer ID (503) is stored along with optional associated consumer ID (504) might actually be stored. This extracting device is referred to as phone 1 (but can be any of the devices listed in FIG. 1). This invention allows for group interaction, as well as social networking of specific interactions between consumers, such as family members or friends. Because extracting devices such as cell phones, RFID readers have a finite amount of memory, it may be necessary for online as well as data repositories be deployed in order to cover as many SKUs as possible. These are represented by the servers (509). In each one of these servers, the logical rules of specific media objects are stored into memory (510). These rules are organized according to IDs (511-512). Each server (which can be a set of dedicated servers in a server farm, on the web using cloud-based services such as SAAS) holds one or more digital object stores (513), each storing one or more digital objects (514). Each server is controlled by at least one central processing unit (515). The management of these digital objects is controlled by the so-called pre-fetch/push digital object manager (516). Algorithms controlling this pre-fetch/push digital object manager are implemented by a central processing unit (517). The pre-fetch/push digital object manager holds for each consumer a specific database (519) of SKUs (520) already purchased by the consumer or his family. In this embodiment, (520) such SKUs are stored in the (or a) database. Another part (521) of the database stores information about SKUs recently scanned or searched by the user, family, or social network (522). These searches could take place on the web or database, using a computer or a mobile device. In this embodiment, v such SKUs (522) are stored in the database. Based on heuristics developed by suppliers and third parties, SKUs in the associated SKU database of FIG. 4 with scanned SKUs may be added to this database. Yet another part (523) of the database includes digital objects (524) that need to be pushed (or downloaded) to devices. In this embodiment, x such SKUs (524) are stored in the database. Yet, another part (525) of database keeps track digital objects (526) that need to be pushed (or downloaded) to devices (there can be more than one). In this embodiment, y such SKUs (526) are stored in the database. This number of SKUs stored in each part of the database, that is n, v, x and y will vary with time. The pre-fetch/push digital object manager may be collocated or remote from one or more of the servers. Servers, pre-fetch/push digital object manager and consumer phone or through one or more wireless or wired network (528). On a regular, scheduled or ad-hoc basis, a command (527) is executed to tag part or whole of the digital objects in the purchased item part (519) of the database and scanned/searched (and associated) part (521) of the database into the digital objects to push to devices part (523) of the database. On a regular, ad-hoc, and/or based on wireless network performance (bandwidth, latency, etc.), a command (529) is issued from the pre-fetch/push digital object manager to the servers, which, in turn, transfers (530) the referenced objects to the consumer phone. This can also be done using synchronization services as i-could, intellisync, active-sync. Push notification technologies that may be used for this purpose include but are not limited technologies such as Apple's Apple Push Notification Service (APNS) (which is supported on iOs) and Cloud to Device Messaging (C2DM) (which is supported in the Android operating system). A phone 2 (531) is associated with phone 1 (501) because the consumer ID (532) of phone 2 is one of those associated with that (504) of phone 1. Phone 2 is connected to one or more other servers through one or more wireless or wired networks (533). Digital objects are transferred (534) from the servers to form 2. These objects do not have to be the same as those transferred to phone 1.

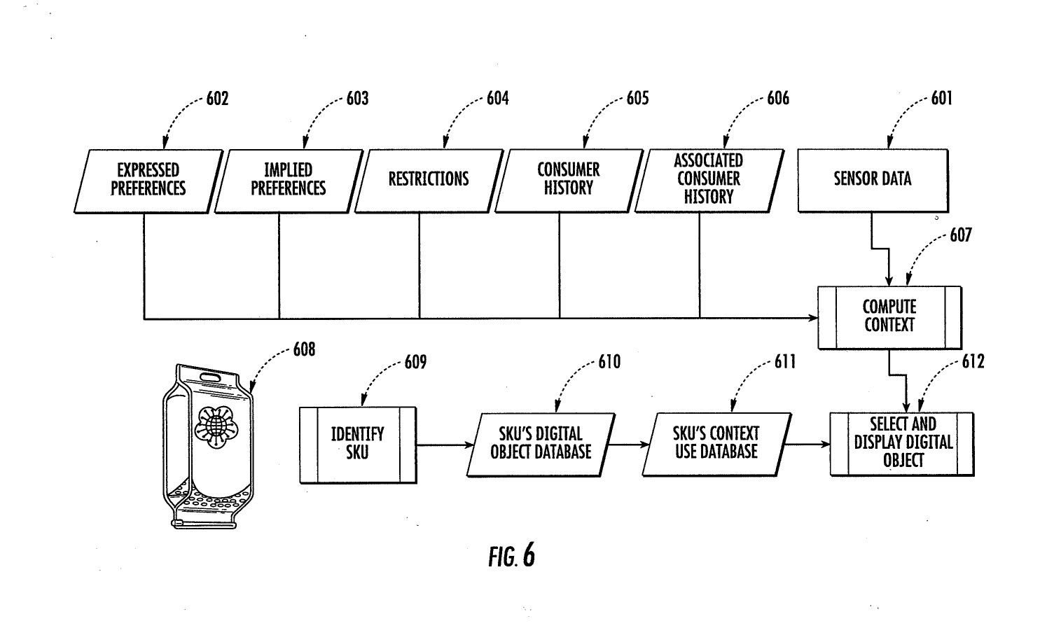

Referring to FIG. 6, methods in which the context of a consumer interaction can be computed are illustrated. One or more of sensor data extracted from one or more portable devices (601), preferences stated by the consumer (603), references gathered from analysis of consumer interactions (603), restrictions (diet, brands, other) indicated by the consumer (604), consumer history such as, but not restricted, purchases or queries (605), and the history of consumers associated (family, social network, neighbors) with the consumer (607) that can be used to compute the context. The computation (601) is performed by the consumer cell phone, a portable device in the vicinity of said cell phone, or on a server where consumer information is kept. The sensor data from multiple phones can be used to enable services where the location of one family member impacts the context (and this interaction) of another family member. This computation also redistributed between consumer phone and one or more servers. Upon scanning of a specific item (608), its SKU is identified (609). The SKU digital object database is queried (610), the SKU context use database is also queried (611). These two databases are preferably but not necessarily stored on the consumer phone. They can be located at the store or remotely at the supplier. Finally the digital object is selected and then presented on one or more cell phones.

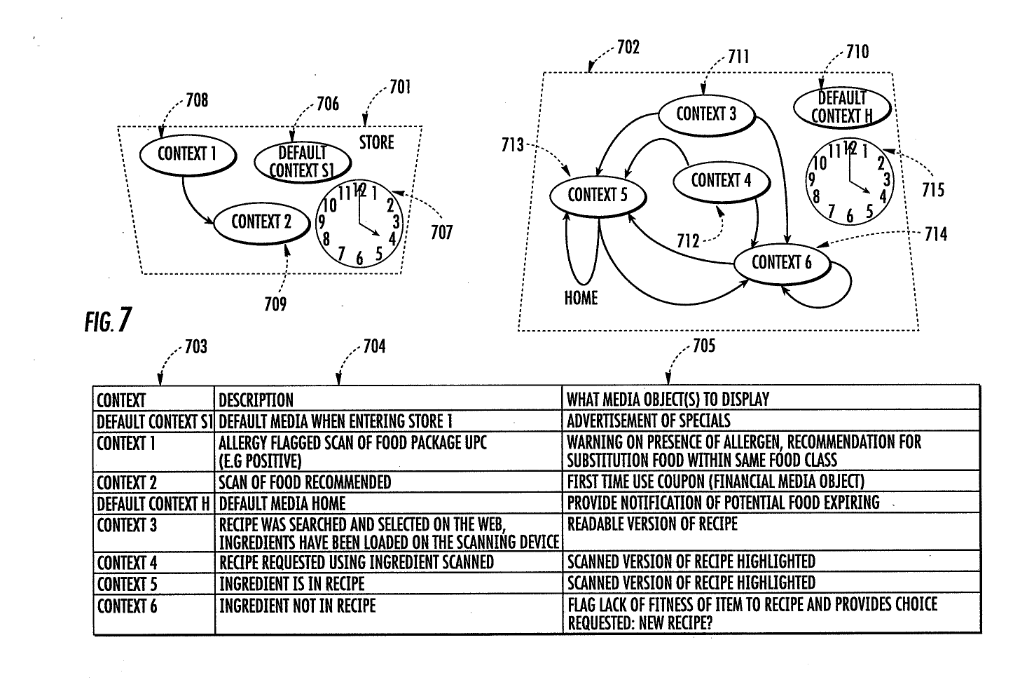

Referring to FIG. 7, nominal examples of the evolution of contexts for both store (701) and home (702) scanning scenarios are illustrated. For each context (703) architected and supported by one or more extracting devices, a description of the context (704) is provided. Column (705) encodes which media objects to present for an associated specific context. In the context of this software description, one can think of context as a state of a state machine. When entering the store, the default context is Default context S1 (706). This context is used to control the displaying of media objects use before any specific interaction is performed by the consumer with any packaging, and also when after some scanning activities are performed, consumer inactivity is establish by the timer (707) expiring. In this embodiment, context 1 (708) reflects the case where a consumer scans a package that happens to contain a food with a specific allergen affecting the consumer, or his/her family. A warning about the presence of the allergen is provided to the consumer and, optionally, recommendations for a proposed substitution SKU is provided. This interaction moves the consumer to context 2 (709). In this context, upon scanning, a different media object is presented, in this case a coupon that fosters the purchase of a, substitution product. This move from context 1 to context 2 and the associated media objects that would be presented to the consumer a typical example of “in hand marketing” enabled by this invention. At home (702), there is an equivalent default context called default context H (710). The scanning device might be displaying information about say food inventory status, such as in this embodiment a reminder that certain foods might be about to go bad (banana is really really black). This embodiment highlights the case where the consumer is working to collect items for a recipe. There are multiple ways to start. The consumer might be checking a recipe on the web from his computer or using a mobile browser. The scanning device can be made aware of this search (through signaling or deposit of information into approach memory location), and information about ingredients transferred dynamically to recipe management software. This action brings the extracting device to context 3 (711). Another starting point might be for the consumer to scan a specific item (712) and based on his item, select a recipe that includes the ingredient. This is context 4. From that point on and until the consumer indicates so or all items of the recipe are scanned for, the scanning device interactions moves back and forth between context 5 (713) when the ingredient scanned is in the recipe and context 6 (714) when it is not. If no action is detected after timer (715) expires; the scanning device is moved back to default context H (701). It should be noted that the same consumer might experience a different interaction—supported by the presentation of different media objects—for the same item at home compared to the store. This is a typical example of the context aware interactive packaging enabled by this invention.

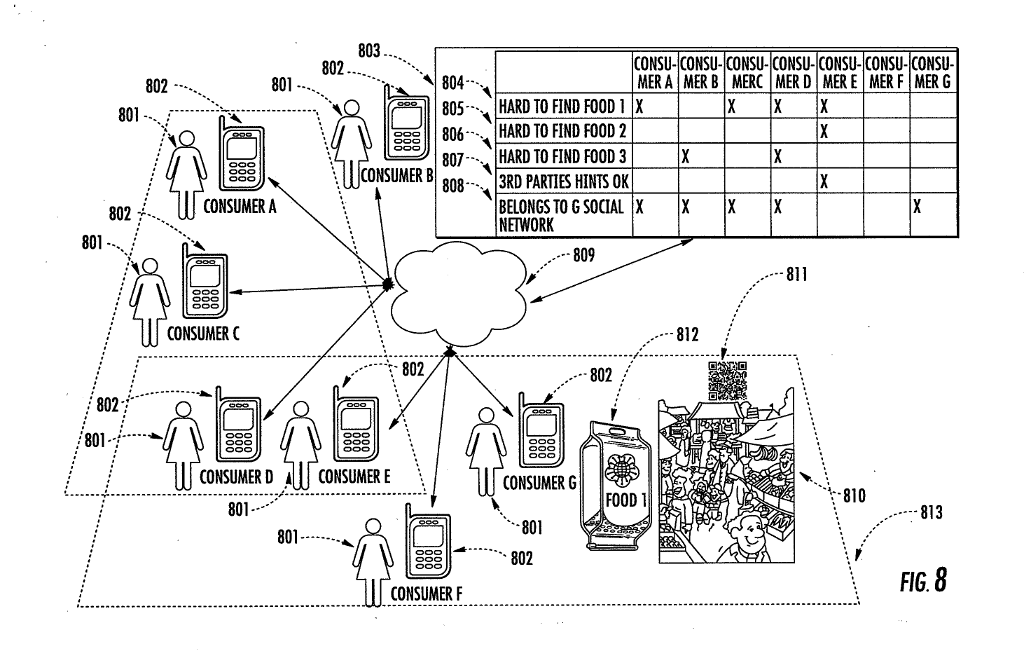

Referring to FIG. 8, scanning of a specific food item used to display multiple media objects on multiple phones, and methods of facilitating a group purchase of said items. A group of consumers (801) each carrying a scanning device, say a cell phone (802). They belong to a food service database hosted on a server which allows, among other services; consumers to help one another find specific food items. In this figure, seven consumers are listed. These consumers register what type of food they seek to find. This registration is done as part of registration, preferences, or analysis of their and other purchases. Food 1 (804) is a choice for consumers A, C, D and E. Food 2 (805) is also the choice of consumer E. At this embodiment illustrates, a specific consumer may register more than one food item. Food 3 (806) is the choice of consumers B and C. Consumer E registers that it is interested to receive information about food and from 3rd parties inside and outside his/her social network. Consumers A, B, C, D and G belong to the same, or one of the same inter-connected, social network(s) (say Facebook, twitter, Google+). The server manages the database the different cell phones of the consumers who are connected to one or more wireless networks (809). Consumer G while shopping at a market (810) scans a mark (811) that identifies the market to be supported for a specific food service (811)—this step can be skipped. Consumer G also a food that is a registered food 1 (812) at said market. This market is within a geographical area (813). Upon scanning of item (812), a message is sent from consumer G phone to the server, which transmits a digital media object to members of consumer G social group and to third parties agreeing to receive such requests who happen to be within the geographical area (813) convert by the market (810). Those consumers will receive in digital object indicating that hard to find food 1 has been spotted and is available for purchase market (810). In this embodiment, only consumers D and E will receive media objects on their cell phone. Optionally, consumer D may receive and additional digital object permission in consumer G to purchase item (812) on her behalf.

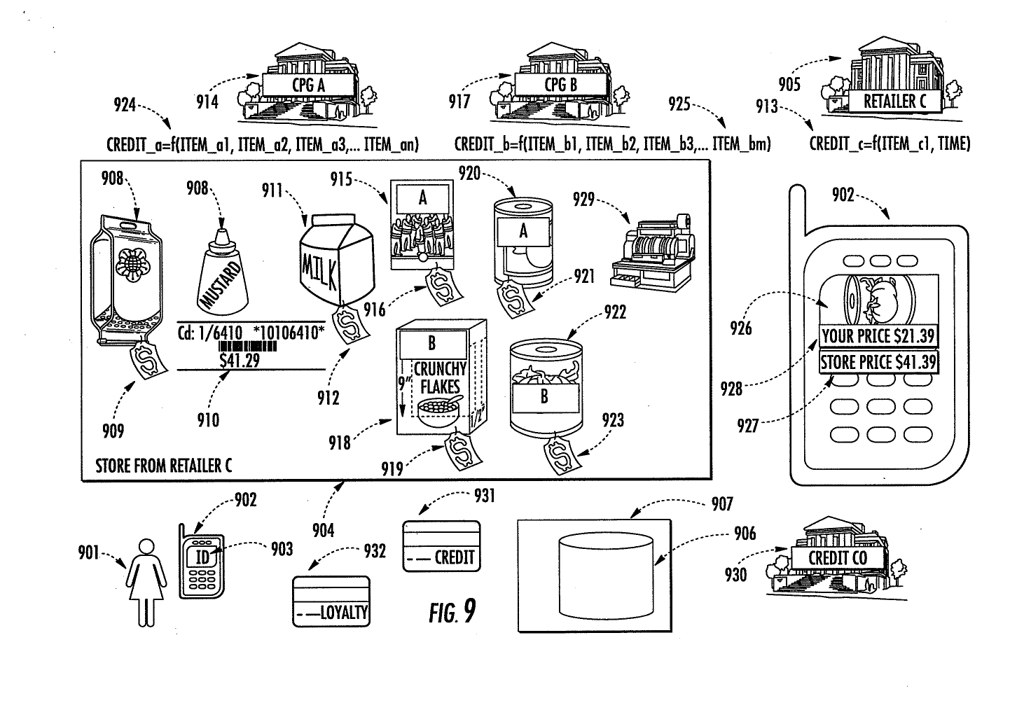

Referring to FIG. 9, another embodiment including enabling customized and dynamic pricing as well as real-time price bidding is illustrated. A consumer (901) owns a mobile device (902) with an ID (903) stored. Consumer operates phone within a store (904) operated by Retailer C (905). Profile and history information (906) are stored in a server (907). At the store, the consumer scans a series of products (908). Pricing information on these products is in the form of the label affixed (909) to the product or affixed to the shelf next to the product (910). Upon scanning of said items, one or more financial objects are displayed on the phone. These financial items may be coupons or offer from one or more suppliers to substitute food scanned with another (say for instance moving from garlic to minced garlic). The consumer scans an item (911), which has a regular price, affixed to it (912). In this embodiment, item (911) is a store item. Upon scanning, a financial object is displayed on the phone that indicates what the price is the consumer will end up paying for this item. This price can be set differently for different times of day, different consumer demographics, or specific conditions, thus allowing a unique consumer centric dynamic pricing to be provided to consumer (901). A cold cola could be priced at higher amount during a festival. This can be used to sell items that are close to their expiration dates, such as—but not limited to—milk products and eggs. Eggs with only 14 days left until use by date can be charged less than those with 21 days left until use by date. Different consumers would experience different prices thus allowing consumer per consumer, item per item pricing. Upon scanning of item (911), the consumer is prompted by one or more new digital objects to purchase cereals. In this embodiment, there are two providers of cereals: CPG A (914) who sells cereal A (915) at a regular price (916) and CPG B (917) who sells cereal B (918) at the regular price (919). In this embodiment, CPG A and CPG B are competing/bidding for business of consumer (901). The consumer will indicate by scanning the chosen produces with a phone based scanner, he/she chooses to scan an item (914), he/she would indicate to CPG A that he/she is choosing its product. Should he/she choose item (918), he/she would indicate to CPG B that he/she's is choosing its product. The CPGs have now the opportunity to offer complementation products. CPG A can offer an offer for item (920) regularly priced at (921). CPG B can offer an offer for item (922) regularly priced at (923). The discount of price or credit (924) offered for item (920) can be made different if the consumer has purchased (915) or not. The discount of price or credit (925) offered for item (922) can be made different if the consumer has purchased (918) or not. To highlight and induce the consumer, the mobile device will display information about the product (926) tailored to the consumer, along with regular (927) as well as effective (982) price. Purchases are registered at a POS (929) terminal. It should be noted that this POS might be a mobile POS, or an application running on the mobile device itself. A credit clearing house—or equivalently bank—(930) can transfer credit the consumer credit card (931) or the consumer loyalty card (932).

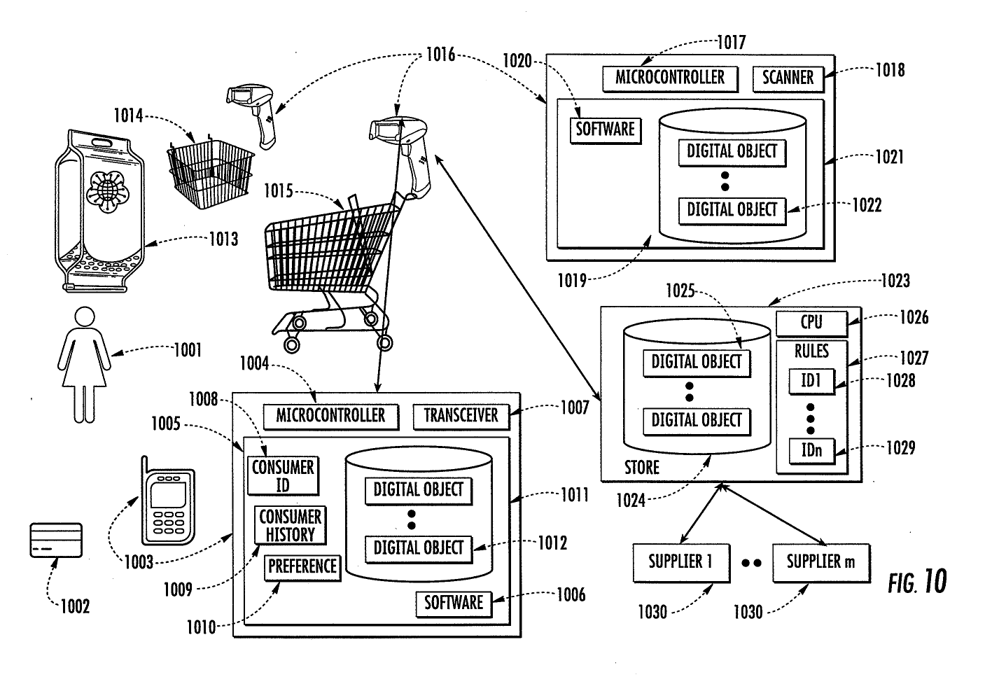

Referring to FIG. 10, another embodiment is illustrated. A consumer (1001) who may have a loyalty card (1002) uses her cell phone (1003) while shopping. The cell phone is brought up close to a food package (304), a merchandising display (305), a shopping basket (306), or a shopping cart (307). The cell phone includes microcontroller (1004), memory (1005) and software (1006) and one more transceiver (1007). The memory also holds information about the consumer such as consumer ID (1008), consumer history (1009) and consumer preferences (1010). The memory also holds an object store (1011) with one or more digital objects (1012). The consumer seeks to purchase item (1013) and places it in the vicinity of shopping cart (1014) or shopping cart (1015). She uses a store provided scanner (1016). It can be attached to the cart (1015) or basket (1014). The scanner includes a microcontroller (1017), a scanning device (1018), memory (1019) to store software (1020). The scanning device might scan barcodes. It includes a digital object Store (1021) that includes one or more digital objects (1022). The scanner is associated with the mobile device. The scanner scans the product (1013) and extracts a unique identifier. As in previous examples, the mobile phone presents one or more digital objects based on the unique identifier. The store maintains a server (1023) that is used in conjunction with the consumer cell phone to provide context aware interaction. The server includes a digital object store (1024) that includes one or more digital objects (1025). The server is controlled by a central processing unit (1026). Program memory (1027) maintains the computing, customization, processing or presentation (e.g. display of images or text, play of video or audio, control of vibration), rules of the digital objects organized by ID (1028-1029). These ID can be the same as or related through database manipulation, taxonomy or algorithmically to the consumer ID (1008). Based on unique identifier, all or part of consumer history (1009) or all or part of preference (1010) or unique ID of specific packages, the store server presents one or more digital objects to the mobile phone (directly or through the scanner). When those digital objects are used to support a real-time pricing/binding service, the store server might be connected to one or more supplier servers (1030).

Emphasis was given herein to visual scanning. As RFID systems become deployed at the item level, information can be exchanged between portable devices, and said item, using radio-wave rather than optical scanning, supporting functionality enabled by this invention and is thus claimed.

The presentation of digital objects can be done using one or more of the following techniques: Display of images and text, playing of video clips, playing of audio, vibrating patterns, change in temperature, changes in textures, changes in shape, changes in patterns, generation of smells, and relational dependencies between these. All these techniques are claimed.

Servers described in this invention can be found in a multitude of devices including, but not limited, personal computer, server farms, enterprise computers, blade servers, mainframe, portable devices, cellphones, tablets, standalone, or shared servers, and cloud based portable devices. For instance, the same mobile device may have scanning software, extraction software, and a server running as separate functions on the same hardware. All these realizations are claimed. Servers can be inter-networked, inter-connected, and connected to other servers, at times under the same administration or security framework, at times under different administration or security frameworks. For instance, a store computer might interface with a consumer database managed by another server. Likewise, a food supplier server might subscribe (as in RSS) to information broadcasted by a specific association server. Functionality enabled by this interconnection or subscription is claimed.

When considering associated devices such as scanner associated with a mobile device, communication to servers can be performed using either communication capability; that is using the scanner wireless capabilities or the mobile device capabilities interchangeably. All these communication methods are claimed.

While this invention describes interactions in terms of food products, nothing precludes the implementation of this invention to other items, including items found around the home and stores such as detergent, cleaning supplies, clothing, receipts, posters, and magazines.

### EMBODIMENT LIST

The following list includes particular embodiments. The list, however, is not limiting and does not exclude alternate embodiments otherwise described or as would be appreciated by one of ordinary skill in the art.

1. A computer-implemented method comprising:

providing a first set of instructions configured to cause a portable device to:

i) scan all or a portion of packaging,

ii) locate a visual indicator in the visible portion of packaging,

iii) map said visual indicator into at least one index, access one or more extraction attributes;

identifying one or more digital objects based on the at least index and the one or more extraction attributes; and

presenting an interactive interface comprising information about the one or more digital objects and a control for selecting a particular digital object of the one or more digital objects.

2. The computer-implemented method of embodiment 1, wherein the one or more extraction attributes are selected from the group consisting of: location; speed; time; velocity; orientation; sound; lighting; vibration; repeated motion; distance to packaging; distance between packaging and nearby related objects; portable device parameters; application parameters; and identification parameters.
3. The computer-implemented method of any one or more of embodiments 1-2 further comprising storing use of the particular digital object into non-volatile memory upon a user selecting the control.
4. The computer-implemented method of any one or more of embodiments 1-3, wherein the step of identifying further comprises:

transmitting the at least one index and the one or more extraction attributes to a second portable device;

accessing, by the second portable device, the at least one index and the one or more extraction attributes; and

identifying one or more digital objects by the second portable database based on the at least one index and the one or more extraction attributes.

5. The computer-implemented method of any one or more of embodiments 1-4 further comprising sending at least one of the one or more digital objects to a third portable device.
6. The computer-implemented method of any one or more of embodiments 1-5 further comprising sending information identifying the particular digital object to a server upon a consumer selecting the control.
7. The computer-implemented method of any one or more of embodiments 1-6, wherein the step of identifying further comprises:

transmitting the at least one index and the one or more extraction attributes to a second portable device;

accessing a second set of one or more extraction attributes by the second portable device; and

identifying one or more digital objects based on the at least one index, the one or more extraction attributes, and the second set of one or more extraction attributes by the second portable device.

8. The computer-implemented method of any one or more of embodiments 1-7, wherein the second set of one or more extraction attributes by the second portable device are selected from the group consisting of location; speed; time; velocity; orientation; sound; lighting; vibration; repeated motion; distance to packaging; distance between packaging and nearby related objects; portable device parameters; application parameters; and identification parameters.
9. The computer-implemented method of any one or more of embodiments 1-8 further comprising sending at least one of the one or more digital objects to a third portable device.
10. The computer-implemented method of any one or more of embodiments 1-9 further comprising sending at least one of the one or more digital objects to a second portable device.
11. The computer-implemented method of any one or more of embodiments 1-10, wherein the one or more digital objects includes at least one of a game, a virtual machine, a form-based questionnaire, a coupon, a discount, an advertisement, a financial instrument, pricing information, nutritional information, allergy information, a recipe, inventory information, geographical information, environmental information or social networking information.
12. The computer-implemented method of embodiment 11, wherein the financial instrument is at least one of a currency, a contract, a bid, an equity, a security, a tax, a fixed security, or indexes thereof.
13. The computer-implemented method of any one or more of embodiments 1-12, wherein where selecting the particular digital objects is based on one or more of extraction attributes, purchase history, credit history, membership in group, time of day, day of week, environmental conditions, preferences or restrictions.
14. The computer-implemented method of any one or more of embodiments 1-13 further comprising:

creating a second index to the particular digital object;

generating one or more unique transaction identifiers based on that second index; and

transmitting one or more transaction data each associated with said identifier to one or more remote servers.

15. A computer-implemented method comprising:

providing a first set of instructions configured to cause a portable device to:
i) scan all or a portion of packaging,
ii) locate a visual indicator in the visible portion of packaging,
iii) map said visual indicator into at least one index,
iv) access one or more extraction attributes, and
v) send the at least one index and the one or more extraction attributes to a server;

receiving, at the server, from the portable device, a first request comprising the at least one index and the one or more extraction attributes;

identifying one or more digital objects by the server, based on the at least one index and the one or more extraction attributes;

sending to the portable device a second set of instructions by the server in response to the first request, configured to cause the portable device to:
i) present an interactive interface comprising information about the one or more digital objects and a control for selecting a particular digital object of the one or more digital objects;
ii) send information identifying the particular digital object to a server upon a consumer selecting the control; and
iii) send to the server, from the portable device, a second request identifying the particular digital object.
   16. The computer-implemented method of embodiment 15 further comprising receiving the second request at the server.
   17. The computer-implemented method of any one or more of embodiments 16-17, wherein the one or more extraction attributes are selected from the group consisting of: location; speed; time; velocity; orientation; sound; lighting; vibration; repeated motion; distance to packaging; distance between packaging and nearby related objects; portable device parameters; application parameters; and identification parameters.
   18. The computer-implemented method of any one or more of embodiments 1-17, wherein the step of identifying further comprises:

querying a second server based on at least one of a context attribute; and

identifying the one or more digital objects based on the context attribute from the second server, the at least one index and the one or more extraction attributes.

19. The computer-implemented method of any one or more of embodiments 1-18 further comprising sending at least one of the one or more digital objects to a second portable device.
20. The computer-implemented method of any one or more of embodiments 1-18, wherein the one or more digital objects includes at least one of a game, a virtual machine, a form-based questionnaire, a coupon, a discount, an advertisement, a financial instrument, pricing information, nutritional information, allergy information, a recipe, inventory information, geographical information, environmental information or social networking information.
21. The computer-implemented method of embodiment 20, wherein the financial instrument is at least one of a currency, a contract, a bid, an equity, a security, a tax, a fixed security, or indexes thereof.
22. The computer-implemented method of any one or more of embodiments 1-21, wherein selecting the particular digital objects is based on one or more of extraction attributes, purchase history, credit history, membership in group, time of day, day of week, environmental conditions, preferences or restrictions.
23. The computer-implemented method of any one or more of embodiments 1-22 further comprising:

creating a second index to the particular digital object;

generating one or more unique transaction identifiers based on that second index; and

transmitting one or more transaction data each associated with said identifier to one or more remote servers.

24. A computer-implemented method comprising:

providing a first set of instructions configured to cause a first portable device to:

i) scan a portion of packaging,

ii) locate a visual indicator in the visible portion of packaging,

iii) map said visual indicator into an index, and access one or more of a first set of extraction attributes;

transmitting the index and the first set of extraction attributes to a second portable device;

accessing one or more of a second set of extraction attributes;

sending the index and the first or second set of extraction attributes to a server by the second portable device;

receiving, at the server, from the second portable device, a first request comprising the index and said attributes;

identifying one or more digital objects by the server based on the index and said attributes;

sending a second set of instructions to the second portable device by the server, in response to the first request, configured to cause the second portable device to:

i) present an interactive interface comprising information about the one or more digital objects and a control for selecting a particular digital object of the one or more digital objects,

ii) send information identifying the particular digital object to a server upon a consumer selecting the control, and

iii) send to the server, from the second portable device, a second request identifying the particular digital object.

25. The computer-implemented method of embodiment 24 further comprising receiving the second request at the server.
26. The computer-implemented method of any one or more of embodiments 24-25, wherein the one or more of a first set of extraction attributes are selected from the group consisting of: location; speed; time; velocity; orientation; sound; lighting; distance to packaging; portable device parameters; application parameters; and identification parameters.
27. The computer-implemented method of any one or more of embodiments 24-26, wherein the one or more of a second set of extraction attributes by the second portable device are selected from the group consisting of: location; speed; time; velocity; orientation; sound; lighting; vibration; repeated motion; distance to packaging; distance between packaging and nearby related objects; portable device parameters; application parameters; and identification parameters.
28. The computer-implemented method of any one or more of embodiments 24-27 further comprising sending at least one of the one or more digital objects to a second portable device.
29. The computer-implemented method of any one or more of embodiments 24-28, wherein the one or more digital objects includes at least one of a game, a virtual machine, a form-based questionnaire, a coupon, a discount, an advertisement, a financial instrument, pricing information, nutritional information, allergy information, a recipe, inventory information, geographical information, environmental information or social networking information.
30. The computer-implemented method of embodiment 29, wherein the financial instrument is at least one of a currency, a contract, a bid, an equity, a security, a tax, a fixed security, or indexes thereof.
31. The computer-implemented method of any one or more of embodiments 24-30, wherein selecting the particular digital objects is based on one or more of extraction attributes, purchase history, credit history, membership in group, time of day, day of week, environmental conditions, or preferences or restrictions.
32. The computer-implemented method of any one or more of embodiments 24-31 further comprising:

creating a second index to the particular digital object;

generating one or more unique transaction identifiers based on that second index; and

transmitting one or more transaction data each associated with said identifier to one or more remote servers.

33. A non-transitory machine-readable storage medium having recorded and stored thereon instructions that, when executed, perform actions including:

scanning a portion of packaging;

locating a visual indicator in the visible portion of packaging:

mapping said visual indicator into at least one index;

accessing one or more context attributes;

presenting an interactive interface comprising information about one or more digital objects;

presenting to a consumer a control for selecting a particular digital object of the one or more digital objects; and

sending information identifying the particular digital object to a server upon a consumer selecting the control.

34. The non-transitory machine-readable storage medium of embodiment 33, wherein the one or more context attributes are selected from the group consisting of: location; speed; time; velocity; orientation; sound; lighting; vibration; repeated motion; distance to packaging; distance between packaging and nearby related objects; portable device parameters; application parameters; and identification parameters.
35. The non-transitory machine-readable storage medium of any one or more of embodiments 33-34, further comprising:

sending the index and one or more extraction attributes to a server; and

receiving a set of instructions, prior to presenting an interactive interface comprising information about one or more digital objects.

36. A non-transitory machine-readable storage medium having recorded and stored thereon instructions that, when executed, performs actions including:

providing a first set of instructions configured to cause a portable device to:

i) scan all or a portion of packaging,

ii) locate a visual indicator in the visible portion of packaging,

iii) map said visual indicator into at least one index,

iv) access one or more extraction attributes;

identifying one or more digital attributes based on the at least one index and the one or more extraction attributes,

presenting an interactive interface comprising information about the one or more digital objects and a control for selecting a particular digital object of the one or more digital objects; and

storing use of the particular digital object into non-volatile memory upon a consumer selecting the control.

37. The non-transitory machine-readable storage medium of embodiment 36, wherein one or more extraction attributes selected from the group consisting of: location; speed; time; velocity; orientation; sound; lighting; vibration; repeated motion; distance to packaging; distance between packaging and nearby related objects; portable device parameters; application parameters; and identification parameters.
38. A non-transitory machine-readable storage medium having recorded and stored thereon instructions that, when executed, performs actions including:

providing a first set of instructions configured to cause a portable device to:

i) scan all or a portion of packaging,

ii) locate a visual indicator in the visible portion of packaging,

iii) map said visual indicator into at least one index,

iv) access one or more extraction attributes;

identifying one or more digital objects based on the at least one index and the one or more extraction attributes;

presenting an interactive interface comprising information about the one or more digital objects and a control for selecting a particular digital object of the one or more digital objects; and

sending information identifying the particular digital object to a server upon a consumer selecting the control.

39. The non-transitory machine-readable storage medium of embodiment 38, wherein the one or more extraction attributes are selected from the group consisting of: location; speed; time; velocity; orientation; sound; lighting; vibration; repeated motion; distance to packaging; distance between packaging and nearby related objects; portable device parameters; application parameters; and identification parameters.
40. An interactive packaging processing system comprising:

one or more portable devices capable of scanning packages, said portable devices comprising a processing unit, memory, and a user interface;

the one or more portable devices capable of extracting one or more extraction attributes;

at least one of the one or more portable devices capable of selecting one or more digital objects based on information from scanning the packages and the one or more attributes and presenting the one or more digital objects to the portable device user interface.

41. The interactive packaging processing system of embodiment 40, wherein the one or more attributes are selected from the group consisting of: location; speed; time; velocity; orientation; sound; lighting; vibration; repeated motion; distance to packaging; distance between packaging and nearby related objects; portable device parameters; application parameters; and identification parameters.
42. An interactive packaging processing system comprising:

one or more portable devices capable of scanning packages, said portable devices comprising a processing unit, memory and user interface and said portable devices capable of extracting one or more extraction attributes;

one or more servers comprising one or more digital objects stores, a central processing unit and memory, said one or more digital objects stores storing one or more digital objects;

at least one portable device capable of scanning a package, extracting a first of set of one or more of said attributes and transmitting information about scanned package;

at least a second portable device capable of extracting a second set of one or more of said attributes;

said at least one portable device capable of exchanging said first set of attributes to a second device;

said portable devices capable of transmitting first set of attributes, second set of attributes and information about scanned package to one or more servers,

said one or more servers capable of selecting one or more digital objects based on scanned package information and attributes, and

said servers capable of transmitting one or more digital objects to one or more portable devices.

43. The interactive packaging processing system of embodiment 42, wherein the one or more attributes are selected from the group consisting of: location; speed; time; velocity; orientation; sound; lighting; vibration; repeated motion; distance to packaging; distance between packaging and nearby related objects; portable device parameters; application parameters; and identification parameters.
44. A computer-implemented method comprising:
b) Providing a first set of instructions configured to cause a portable device to:
   i) Scan all or a portion of packaging;
   ii) Locate a visual indicator in the visible portion of packaging;
   iii) Map said visual indicator into an index, and/or indices;
   iv) Access one or more extraction attributes from the group consisting of: location, speed, time, velocity, orientation, sound, lighting, vibration, repeated motion, distance to packaging, distance between packaging and nearby related objects, portable device parameters, application parameters, identification parameters;
c) Based on the index and attributes, the portable device identifying one or more digital objects;
   i) Present an interactive interface comprising information about the one or more digital objects and a control for selecting a particular digital object of the one or more digital objects; and,
   ii) Upon a consumer selecting the control, store use of the particular media into non-volatile memory.
      45. A computer-implemented method comprising:
d) Providing a first set of instructions configured to cause a portable device to:
   i) Scan all or a portion of packaging;
   ii) Locate a visual indicator in the visible portion of packaging;
   iii) Map said visual indicator into an index, and/or indices;
   iv) Access one or more extraction attributes from the group consisting of: location, speed, time, velocity, orientation, sound, lighting, vibration, repeated motion, distance to packaging, distance between packaging and nearby related objects, portable device parameters, application parameters, identification parameters;
e) Based on the index and attributes, the portable device identifying one or more digital objects;
   i) Present an interactive interface comprising information about the one or more digital objects and a control for selecting a particular digital object of the one or more digital objects;
   ii) Upon a consumer selecting the control, send information identifying the particular digital object to a server.
      46. A computer-implemented method comprising:
f) Providing a first set of instructions configured to cause a portable device to:
   i) Scan all or a portion of packaging;
   ii) Locate a visual indicator in the visible portion of packaging;
   iii) Map said visual indicator into an index, and/or indices;
   iv) Access one or more extraction attributes from the group consisting of: location, speed, time, velocity, orientation, sound, lighting, vibration, repeated motion, distance to packaging, distance between packaging and nearby related objects, portable device parameters, application parameters, identification parameters;
   v) Send the index and attributes to a server;
g) Receiving, at the server, from the portable device, a first request comprising the index and attributes;
h) Server querying a second server based on at least one of context attributes;
i) Based on the response from second server to said query, index and attributes, the server identifying one or more digital objects;
j) In response to the first request, the server sending to the portable device a second set of instructions configured to cause the portable device to:
   i) Present an interactive interface comprising information about the one or more digital objects and a control for selecting a particular digital object of the one or more digital objects;
   ii) Upon a consumer selecting the control, send information identifying the particular digital object to a server;
   iii) Receiving at the server, from the portable device, a second request identifying the particular digital object.
      47. A computer-implemented method comprising:
k) Providing a first set of instructions configured to cause a first portable device to:
   i) Scan all or a portion of packaging;
   ii) Locate a visual indicator in the visible portion of packaging;
   iii) Map said visual indicator into an index, and/or indices;
   iv) Access one or more extraction attributes from the group consisting of: location, speed, time, velocity, orientation, sound, lighting, vibration, repeated motion, distance to packaging, distance between packaging and nearby related objects, portable device parameters, application parameters, identification parameters;
   v) Transmitting index and attributes to a second portable device;
   vi) Second portable device accessing location, speed, time, velocity, orientation, sound, lighting, vibration, repeated motion, distance to packaging, distance between packaging and nearby related objects, portable device parameters, application parameters, identification parameters;
l) Based on the index and attributes, the second portable device identifying one or more digital objects;
   i) Present an interactive interface comprising information about the one or more digital objects and a control for selecting a particular digital object of the one or more digital objects;
   ii) Upon a consumer selecting the control, store use of the particular media into non-volatile memory.
      48. A computer-implemented method comprising:
m) Providing a first set of instructions configured to cause a first portable device to:
   i) Scan all or a portion of packaging;
   ii) Locate a visual indicator in the visible portion of packaging;
   iii) Map said visual indicator into an index, and/or indices;
   iv) Access one or more extraction attributes from the group consisting of: location, speed, time, velocity, orientation, sound, lighting, vibration, repeated motion, distance to packaging, distance between packaging and nearby related objects, portable device parameters, application parameters, identification parameters;
   v) Transmitting index and attributes to a second portable device;
   vi) Second portable device accessing one or more second set extraction attributes from the group consisting of: location, speed, time, velocity, orientation, sound, lighting, vibration, repeated motion, distance to packaging, distance between packaging and nearby related objects, portable device parameters, application parameters, identification parameters;
n) Based on the index and attributes, the second portable device identifying one or more digital objects;
   i) Present an interactive interface comprising information about the one or more digital objects and a control for selecting a particular digital object of the one or more digital objects;
   ii) Upon a consumer selecting the control, send information identifying the particular digital object to a server.
      49. A non-transitory machine-readable storage medium having recorded and stored thereon instructions that, when executed, performs actions including:
iii) Scan all or a portion of packaging;
iv) Locate a visual indicator in the visible portion of packaging;
v) Map said visual indicator into an index, and/or indices;
vi) Access one or more extraction attributes from the group consisting of: location, speed, time, velocity, orientation, sound, lighting, vibration, repeated motion, distance to packaging, distance between packaging and nearby related objects, portable device parameters, application parameters, identification parameters;
o) Send the index and attributes to a server;
p) Receiving a set of instructions;
q) Presenting an interactive interface comprising information about one or more digital objects;
r) Presenting to a consumer a control for selecting a particular digital object of the one or more digital objects;
s) Upon a consumer selecting the control, sending information identifying the particular digital object to a server.

All numbers expressed given in the form for some type of ingredients, goods, properties, and/or other parameters used in this specification, and claims, are to be understood as optionally modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits, and by applying ordinary rounding techniques.

The references cited throughout this application, are incorporated for all purposes apparent herein and in the references themselves as if each reference was fully set forth. For the sake of presentation, specific ones of these references are cited at particular locations herein. A citation of a reference at a particular location indicates a manner in which the teachings of the reference are incorporated. However, a citation of a reference at a particular location does not limit the manner in which all of the teachings of the cited reference are incorporated for all purposes.

The skilled artisan will readily appreciate that the methods and systems herein may be implemented with multiple consumers, multiple prospective consumers, and/or multiple registered consumers.

The methods herein may be implemented on myriad types of devices and/or combinations of devices. Combinations of devices may be functionally connected by physical or wireless connections as known in the art. A device may include a processor, a memory device, a communication interface, a data storage device, and a display, which may be a touchscreen display. These components may be connected via a system bus in the device, and/or via other appropriate interfaces within the device.

The memory device may be or include a device such as a Dynamic Random Access Memory (D-RAM), Static RAM (S-RAM), or other RAM or a flash memory.

The data storage device may be or include a hard disk, a magneto-optical medium, an optical medium such as a CD-ROM, a digital versatile disk (DVDs), or Blu-Ray disc (BD), or other type of device for electronic data storage. The data storage device may store instructions that define the application, and/or data that is used by the application.

The communication interface may be, for example, a communications port, a wired transceiver, a wireless transceiver, and/or a network card. The communication interface may be capable of communicating using technologies such as Ethernet, fiber optics, microwave, xDSL (Digital Subscriber Line), Wireless Local Area Network (WLAN) technology, wireless cellular technology, and/or any other appropriate technology.

The touchscreen display may be based on one or more technologies such as resistive touchscreen technology, surface acoustic wave technology, surface capacitave technology, projected capacitive technology, and/or any other appropriate touchscreen technology. When the touchscreen receives data that indicates user (e.g., a consumer, prospective consumer, or registered consumer) input, the touchscreen may provide data to an application implementing at least a portion of a method herein.

Although actions are described herein as being performed by the application, this is done for ease of description and it should be understood that these actions are actually performed by the processor (in conjunction with a persistent storage device, network interface, memory, and/or peripheral device interface) in the device, according to instructions defined in the application. The instructions may be stored on a computer readable medium. Alternatively or additionally, the memory device and/or the data storage device in the device may store instructions which, when executed by the processor, cause the processor to perform any feature or any combination of features described above as performed by the application. Alternatively or additionally, the memory device and/or the data storage device in the device may store instructions which, when executed by the processor, cause the processor to perform (in conjunction with the memory device, communication interface, data storage device, and/or the display, which may be a touchscreen display) any feature or any combination of features described above as performed by the application.

As used herein, the term “processor” broadly refers to and is not limited to a single- or multi-core central processing unit (CPU), a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

The features described herein may also be implemented, mutatis mutandis, on a desktop computer, a laptop computer, a netbook, a cellular phone, a personal digital assistant (PDA), or any other appropriate type of computing device or data processing device.

Although features and elements are described above in particular combinations, each feature or element can be used alone or in any combination with or without the other features and elements. For example, each feature or element as described above may be used alone without the other features and elements or in various combinations with or without other features and elements. Sub-elements of the methods and features described above may be performed in any arbitrary order (including concurrently), in any combination or sub-combination.

Further embodiments herein may be formed by supplementing an embodiment with one or more element from any one or more other embodiment herein, and/or substituting one or more element from one embodiment with one or more element from one or more other embodiment herein.

It is understood, therefore, that this invention is not limited to the particular embodiments disclosed, but is intended to cover all modifications which are within the spirit and scope of the invention as defined by the appended claims; the above description; and/or shown in the attached drawings.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A computer-implemented method comprising:
providing a first set of instructions configured to cause a portable device to:
i) scan all or a portion of packaging,
ii) locate a visual indicator in the visible portion of packaging,
iii) map said visual indicator into at least one index,
iv) access one or more extraction attributes;
identifying one or more digital objects based on the at least one index and the one or more extraction attributes; and
presenting an interactive interface comprising information about the one or more digital objects and a control for selecting a particular digital object of the one or more digital objects.

2. The computer-implemented method of claim 1, wherein the one or more extraction attributes selected from the group consisting of: location; speed; time; velocity; orientation; sound; lighting; vibration; repeated motion; distance to packaging; distance between packaging and nearby related objects; portable device parameters; application parameters; and identification parameters.

3. The computer-implemented method of claim 1 further comprising storing use of the particular digital object into non-volatile memory upon a user selecting the control.

4. The computer-implemented method of claim 3, wherein the step of identifying further comprises:
transmitting the at least one index and the one or more extraction attributes to a second portable device;
accessing, by the second portable device, the at least one index and the one ore more extraction attributes; and
identifying one or more digital objects by the second portable database based on the at least one index and the one or more extraction attributes.

5. The computer-implemented method of claim 4 further comprising sending at least one of the one or more digital objects to a third portable device.

6. The computer-implemented method of claim 1 further comprising sending information identifying the particular digital object to a server upon a consumer selecting the control.

7. The computer-implemented method of claim 6, wherein the step of identifying further comprises:
transmitting the at least one index and the one or more extraction attributes to a second portable device;
accessing a second set of one or more extraction attributes by the second portable device selected from the group consisting of location; speed; time; velocity; orientation; sound; lighting; vibration; repeated motion; distance to packaging; distance between packaging and nearby related objects; portable device parameters; application parameters; and identification parameters; and
identifying one or more digital objects based on the at least one index, the one or more extraction attributes, and the second set of one or more extraction attributes by the second portable device.

8. The computer-implemented method of claim 7 further comprising sending at least one of the one or more digital objects to a third portable device.

9. The computer-implemented method of claim 1 further comprising sending at least one of the one or more digital objects to a second portable device.

10. The computer-implemented method of claim 1, wherein the one or more digital objects includes at least one of a game, a virtual machine, a form-based questionnaire, a coupon, a discount, an advertisement, a financial instrument, pricing information, nutritional information, allergy information, a recipe, inventory information, geographical information, environmental information or social networking information.

11. The computer-implemented method of claim 10, wherein the financial instrument is a currency, a contract, a bid, an equity, a security, a tax, a fixed security, or indexes thereof.

12. The computer-implemented method of claim 1, wherein where selecting the particular digital objects is based on one or more of extraction attributes, purchase history, credit history, membership in group, time of day, day of week, environmental conditions, preferences or restrictions.

13. The computer-implemented method of claim 1 further comprising:
creating a second index to the particular digital object;
generating one or more unique transaction identifiers based on that second index; and
transmitting one or more transaction data each associated with said identifier to one or more remote servers.

14. A computer-implemented method comprising:
providing a first set of instructions configured to cause a portable device to:
i) scan all or a portion of packaging,
ii) locate a visual indicator in the visible portion of packaging,
iii) map said visual indicator into at least one index,
iv) access one or more extraction attributes, and
v) send the at least one index and the one or more extraction attributes to a server;
receiving, at the server, from the portable device, a first request comprising the at least one index and the one or more extraction attributes;
identifying one or more digital objects by the server, based on the at least one index and the one or more extraction attributes;
sending to the portable device a second set of instructions by the server in response to the first request, configured to cause the portable device to:
i) present an interactive interface comprising information about the one or more digital objects and a control for selecting a particular digital object of the one or more digital objects;
ii) send information identifying the particular digital object to a server upon a consumer selecting the control; and
iii) send to the server, from the portable device, a second request identifying the particular digital object.

15. The computer-implemented method of claim 14, wherein the one or more extraction attributes are selected from the group consisting of: location; speed; time; velocity; orientation; sound; lighting; vibration; repeated motion; distance to packaging; distance between packaging and nearby related objects; portable device parameters; application parameters; and identification parameters.

16. The computer-implemented method of claim 14 further comprising receiving the second request.

17. The computer-implemented method of claim 14, wherein the step of identifying further comprises:
querying a second server based on at least one of a context attribute; and
identifying the one or more digital objects based on the context attribute from the second server, the at least one index and the one or more extraction attributes.

18. The computer-implemented method of claim 14 further comprising sending at least one of the one or more digital objects to a second portable device.

19. The computer-implemented method of claim 14, wherein the one or more digital objects includes at least one of a game, a virtual machine, a form-based questionnaire, a coupon, a discount, an advertisement, a financial instrument, pricing information, nutritional information, allergy information, a recipe, inventory information, geographical information, environmental information or social networking information.

20. The computer-implemented method of claim 19, wherein the financial instrument is a currency, a contract, a bid, an equity, a security, a tax, a fixed security, or indexes thereof.

21. The computer-implemented method of claim 14, wherein selecting the particular digital objects is based on one or more of extraction attributes, purchase history, credit history, membership in group, time of day, day of week, environmental conditions, preferences or restrictions.

22. The computer-implemented method of claim 14 further comprising:
creating a second index to the particular digital object;
generating one or more unique transaction identifiers based on that second index; and
transmitting one or more transaction data each associated with said identifier to one or more remote servers.

23. A computer-implemented method comprising:
providing a first set of instructions configured to cause a first portable device to:
i) scan a portion of packaging,
ii) locate a visual indicator in the visible portion of packaging,
iii) map said visual indicator into an index, and
iv) access one or more of a first set of extraction attributes;
transmitting the index and the first set of extraction attributes to a second portable device;
accessing one or more of a second set of extraction attributes;
sending the index and the first or second set of extraction attributes to a server by the second portable device;
receiving, at the server, from the second portable device, a first request comprising the index and said attributes;
identifying one or more digital objects by the server based on the index and said attributes;
sending a second set of instructions to the second portable device by the server, in response to the first request, configured to cause the second portable device to:
i) present an interactive interface comprising information about the one or more digital objects and a control for selecting a particular digital object of the one or more digital objects,
ii) send information identifying the particular digital object to a server upon a consumer selecting the control, and
iii) send to the server, from the second portable device, a second request identifying the particular digital object.

24. The computer-implemented method of claim 23, wherein the one or more of a first set of extraction attributes are selected from the group consisting of: location; speed; time; velocity; orientation; sound; lighting; distance to packaging; portable device parameters; application parameters; and identification parameters.

25. The computer-implemented method of claim 23, wherein the one or more of a second set of extraction attributes by the second portable device selected from the group consisting of: location; speed; time; velocity; orientation; sound; lighting; vibration; repeated motion; distance to packaging; distance between packaging and nearby related objects; portable device parameters; application parameters; and identification parameters.

26. The computer-implemented method of claim 23 further comprising receiving the second request by the server.

27. The computer-implemented method of claim 23 further comprising sending at least one of the one or more digital objects to a second portable device.

28. The computer-implemented method of claim 23, wherein the one or more digital objects includes at least one of a game, a virtual machine, a form-based questionnaire, a coupon, a discount, an advertisement, a financial instrument, pricing information, nutritional information, allergy information, a recipe, inventory information, geographical information, environmental information or social networking information.

29. The computer-implemented method of claim 28, wherein the financial instrument is a currency, a contract, a bid, an equity, a security, a tax, a fixed security, or indexes thereof.

30. The computer-implemented method of claim 23, wherein selecting the particular digital objects is based on one or more of extraction attributes, purchase history, credit history, membership in group, time of day, day of week, environmental conditions, preferences or restrictions.

31. The computer-implemented method of claim 23 further comprising:
creating a second index to the particular digital object;
generating one or more unique transaction identifiers based on that second index; and
transmitting one or more transaction data each associated with said identifier to one or more remote servers.

32. A non-transitory machine-readable storage medium having recorded and stored thereon instructions that, when executed, perform actions including:
scanning a portion of packaging;
locating a visual indicator in the visible portion of packaging:
mapping said visual indicator into at least one index;
accessing one or more context attributes;
presenting an interactive interface comprising information about one or more digital objects;
presenting to a consumer a control for selecting a particular digital object of the one or more digital objects; and
sending information identifying the particular digital object to a server upon a consumer selecting the control.

33. The non-transitory machine-readable storage medium of claim 32, wherein the one or more context attributes are selected from the group consisting of: location; speed; time; velocity; orientation; sound; lighting; vibration; repeated motion; distance to packaging; distance between packaging and nearby related objects; portable device parameters; application parameters; and identification parameters.

34. The non-transitory machine-readable storage medium of claim 32, further comprising:
sending the index and one or more extraction attributes to a server; and
receiving a set of instructions, prior to presenting an interactive interface comprising information about one or more digital objects.

35. A non-transitory machine-readable storage medium having recorded and stored thereon instructions that, when executed, performs actions including:
providing a first set of instructions configured to cause a portable device to:
iv) scan all or a portion of packaging,
v) locate a visual indicator in the visible portion of packaging,
vi) map said visual indicator into at least one index,
vii) access one or more extraction attributes;
identifying one or more digital attributes based on the at least one index and the one or more extraction attributes,
presenting an interactive interface comprising information about the one or more digital objects and a control for selecting a particular digital object of the one or more digital objects; and
storing use of the particular digital object into non-volatile memory upon a consumer selecting the control.

36. The non-transitory machine-readable storage medium of claim 35, wherein the one or more extraction attributes are selected from the group consisting of: location; speed; time; velocity; orientation; sound; lighting; vibration; repeated motion; distance to packaging; distance between packaging and nearby related objects; portable device parameters; application parameters; and identification parameters.

37. A non-transitory machine-readable storage medium having recorded and stored thereon instructions that, when executed, performs actions including:
providing a first set of instructions configured to cause a portable device to:
iv) scan all or a portion of packaging,
v) locate a visual indicator in the visible portion of packaging,
vi) map said visual indicator into at least one index,
vii) access one or more extraction attributes;
identifying one or more digital objects based on the at least one index and the one or more extraction attributes;
presenting an interactive interface comprising information about the one or more digital objects and a control for selecting a particular digital object of the one or more digital objects; and
sending information identifying the particular digital object to a server upon a consumer selecting the control.

38. The non-transitory machine-readable storage medium of claim 37, wherein the one or more extraction attributes are selected from the group consisting of: location; speed; time; velocity; orientation; sound; lighting; vibration; repeated motion; distance to packaging; distance between packaging and nearby related objects; portable device parameters; application parameters; and identification parameters.

39. An interactive packaging processing system comprising:
one or more portable devices capable of scanning packages, said portable devices comprising a processing unit, memory, and a user interface;
the one or more portable devices capable of extracting one or more extraction attributes;
at least one of the one or more portable devices capable of selecting one or more digital objects based on information from scanning the packages and the one or more attributes and presenting the one or more digital objects to the portable device user interface.

40. The interactive packaging processing system of claim 39, wherein the one or more extraction attributes are selected from the group consisting of: location; speed; time; velocity; orientation; sound; lighting; vibration; repeated motion; distance to packaging; distance between packaging and nearby related objects; portable device parameters; application parameters; and identification parameters.

41. An interactive packaging processing system comprising:
one or more portable devices capable of scanning packages, said portable devices comprising a processing unit, memory and user interface and said portable devices capable of extracting one or more extraction attributes;
one or more servers comprising one or more digital objects stores, a central processing unit and memory, said one or more digital objects stores storing one or more digital objects;
at least one portable device capable of scanning a package, extracting a first of set of one or more of said attributes and transmitting information about scanned package;
at least a second portable device capable of extracting a second set of one or more of said attributes;
said at least one portable device capable of exchanging said first set of attributes to a second device;
said portable devices capable of transmitting first set of attributes, second set of attributes and information about scanned package to one or more servers,
said one or more servers capable of selecting one or more digital objects based on scanned package information and attributes, and
said servers capable of transmitting one or more digital objects to one or more portable devices.

42. The interactive packaging processing system of claim 41, wherein the one or more extraction attributes are selected from the group consisting of: location; speed; time; velocity; orientation; sound; lighting; vibration; repeated motion; distance to packaging; distance between packaging and nearby related objects; portable device parameters; application parameters; and identification parameters.
